(19) United States
(12) Patent Application Publication
(10) Pub. No.: US 2025/0388136 A1
(43) Pub. Date: Dec. 25, 2025

(54) SEAT POSITION ADJUSTING APPARATUS WITH IMPROVED ASSEMBLY

(71) Applicants: DAS CO., LTD, Gyeongju-si (KR); DURING CO., LTD, Incheon (KR)

(72) Inventors: Kwang Su MOON, Hwaseong-si (KR); Kwang Sin LEE, Suwon-si (KR); Byung Yoon CHOI, Seoul (KR); Sung Won KANG, Incheon (KR); In Yong PARK, Incheon (KR); Ji Haeng JUNG, Incheon (KR)

(21) Appl. No.: 19/218,451

(22) Filed: May 26, 2025

(30) Foreign Application Priority Data
Jun. 19, 2024 (KR) 10-2024-0079897

(51) Int. Cl. B60N 2/16; B60N 2/02; B60N 2/18

(52) U.S. Cl. CPC B60N 2/166; B60N 2/02253; B60N 2/1615; B60N 2/1835; B60N 2/1842; B60N 2002/0208

(57) ABSTRACT

The present disclosure provides a seat position adjustment apparatus with improved assemblability, wherein the assemblability is improved and the weight is reduced by individually modifying the shapes of a mounting part and a gear part and improving their coupling structure, the seat position adjustment apparatus including a driving unit including a motor in which a drive shaft is formed, a gear part, wherein a curved surface part extending along a direction of rotation about a first axis extending bilaterally is formed in an outer portion of the gear part, and the gear part is gear-coupled to the drive shaft, a rod part coupled to the gear part such that the rod part passes through the gear part, receives power from the drive shaft, and moves forward or rearward, and a mounting part, wherein upper portions of a curved plate structure surrounding the curved surface part at a front and a rear of the gear part, respectively, envelop the rod part to form respective through-holes each having a vertical length that is relatively greater than a vertical thickness of the rod part, wherein, in a state in which the mounting part is fixed, a seat connected to the rod part is moved in accordance with a movement of the rod part.

### TECHNICAL FIELD

The present disclosure relates to a seat position adjustment apparatus, and more particularly, to a seat position adjustment apparatus with improved assemblability for use in a vehicle seat.

### BACKGROUND ART

Unless otherwise indicated herein, the descriptions in this section are not prior art to the claims of the present application and are not admitted to be prior art by virtue of their inclusion in this section.

Generally, a vehicle seat includes a seat cushion, which is fixed to a floor inside a vehicle and supports an occupant's load, and a seatback, which supports the occupant's upper body, wherein a seat frame is arranged inside the seat cushion and the seatback.

A vehicle seat is raised or lowered by operation of a vehicle seat height adjustment apparatus, which is fixed to a vehicle or a rail at a lower portion of the seat, and a vehicle seat position adjustment apparatus is fixed to the vehicle or the rail to be rotatable according to movement of the seat.

A conventional vehicle seat position adjustment apparatus is configured such that a driving unit is fixed to a vehicle or a rail through the assembly of a housing bracket and a rotating bracket, which are axially coupled with the driving unit that includes a lead screw, and the driving unit and the rotating bracket rotate in accordance with operation of the driving unit.

However, existing seat position adjustment apparatuses are installed in a vehicle through assembly of brackets, which increases the time required for assembly, and a plurality of brackets lead to higher weight and increased manufacturing costs, consequently worsening the fuel efficiency or electric energy efficiency of the vehicle.

Therefore, to enhance the manufacturing convenience of a seat position adjustment apparatus and to improve the fuel efficiency of a vehicle in which the seat position adjustment apparatus is installed, it is necessary to improve the assemblability and reduce the weight of the seat position adjustment apparatus.

In this regard, Korean Patent Registration No. 10-0885096 discloses an automobile seat height adjustment apparatus, and Korean Patent Publication No. 10-2014-0066582 discloses a driving unit for vehicle electric seat height adjustment.

However, these conventional inventions do not disclose a technology for improving the assemblability and reducing the weight of a seat position adjustment apparatus.

### DISCLOSURE OF INVENTION

### Technical Problem

The present disclosure is to provide a seat position adjustment apparatus that offers improved assemblability and reduced weight through modifications to the shapes of a mounting part and a gear part, and an improved coupling structure thereof.

In addition, the technical problems are not limited to those described above, and it will be apparent that other technical problems may also be derived from the following description.

### Solution to Problem

According to an embodiment of the present disclosure, a seat position adjustment apparatus with improved assemblability includes a driving unit including a motor in which a drive shaft is formed, a gear part, wherein a curved surface part extending along a direction of rotation about a first axis extending bilaterally is formed in an outer portion of the gear part, and the gear part is gear-coupled to the drive shaft, a rod part coupled to the gear part such that the rod part passes through the gear part, receives power from the drive shaft, and moves forward or rearward, and a mounting part, wherein upper portions of a curved plate structure surrounding the curved surface part at a front and a rear of the gear part, respectively, envelop the rod part to form respective through-holes each having a vertical length that is relatively greater than a vertical thickness of the rod part, wherein, in a state in which the mounting part is fixed, a seat connected to the rod part is moved in accordance with a movement of the rod part.

In addition, the mounting part may be formed in an arc shape of a large circular segment, may be in close contact with the curved surface part, and may be coupled to the gear part to be able to slide along the direction of rotation about the first axis.

In addition, the gear part may include a case, wherein a plurality of ribs forming the curved surface part are formed on an outer side of the case, and hollows are formed at a front and a rear of the case to open an internal space to an exterior such that the rod part passes therethrough, and a protrusion formed to protrude from a lower portion of the case.

In addition, in the mounting part, a sliding groove into which the protrusion is inserted may be formed by recessing a portion of the mounting part that corresponds to a path along which the protrusion rotationally moves about the first axis during a movement of the seat.

In addition, in the mounting part, a slot groove connected to the sliding groove may be formed by recessing a portion of one side surface of the mounting part toward the sliding groove.

In addition, an inner edge of one side surface of the mounting part may be machined to be tapered such that an inclined surface is formed.

In addition, the gear part may further include a worm coupled to the drive shaft in the internal space, and a gear nut, wherein, in the internal space, an inner surface of the gear nut is screw-coupled to the rod part, and an outer surface of the gear nut is gear-coupled to the worm.

### Advantageous Effects of Invention

According to an embodiment of the present disclosure, unlike conventional inventions, because the coupling between a gear part and a mounting part in a seat position adjustment apparatus with improved assemblability is performed in a slot manner, the use of brackets and rivets for coupling between the gear part and the mounting part is unnecessary, which provides the advantage that the overall weight is reduced.

Furthermore, unlike conventional inventions, in the seat position adjustment apparatus with improved assemblability, the mounting part is formed in a shape that surrounds and is in close contact with an outer portion of the gear part, which provides the advantage that the weight of material used for fabrication is reduced and assembly between the gear part and the mounting part is facilitated.

In addition, unlike conventional inventions, in the seat position adjustment apparatus with improved assemblability, the gear part is rotatably coupled to the mounting part such that an outer portion of the gear part is in close contact with an inner surface of the mounting part, which provides the advantage that it is unnecessary to use rivets to rotatably couple the mounting part to the gear part.

In addition, because the mounting part is fabricated in a bearing bracket shape with an opening portion formed on its upper portion by bending a plate-shaped material, the volume of the material is minimized, machining of the material is facilitated, and the cross-sectional thickness of the mounting part surrounding the gear part is uniform, thereby enabling an improved weight reduction effect.

In addition, the effects of the present disclosure are naturally exhibited by the configurations to be described below, regardless of whether the inventor recognizes them, and thus, the above-described effects are merely a few effects based on the following descriptions, and it should not be recognized that the inventor has described all the effects that have been figured out or are present. In addition, the effects of the present disclosure should be further determined by the overall description of the specification, even if an effect is not described in an explicit sentence but it can be recognized through the present specification by a person skilled in the art to which the present disclosure pertains, it should be regarded as the effect described in the present specification.

### BRIEF DESCRIPTION OF DRAWINGS

FIG. 1 is a perspective view of an assemblability-improved seat position adjustment apparatus according to an embodiment of the present disclosure.

FIGS. 2 and 3 are exploded perspective views of the assemblability-improved seat position adjustment apparatus of FIG. 1, viewed from different angles.

FIGS. 4 and 5 are exploded perspective views of the assemblability-improved seat position adjustment apparatus of FIG. 1 with a part thereof disassembled.

FIG. 6 is a cross-sectional view of the assemblability-improved seat position adjustment apparatus of FIG. 1, taken along line I-I′.

FIGS. 7 and 8 are schematic views illustrating various operating states of the assemblability-improved seat position adjustment apparatus of FIG. 1 when installed.

FIG. 9 is a perspective view illustrating another embodiment of a mounting part included in the assemblability-improved seat position adjustment apparatus of FIG. 1.

### MODE FOR THE INVENTION

Hereinafter, a configuration, operation, and effects of a seat position adjustment apparatus with improved assemblability according to a preferred embodiment will be described with reference to the accompanying drawings. It should be noted that in the accompanying drawings, components may be omitted or schematically illustrated for convenience and clarity, and the size of each component does not necessarily reflect its actual scale. Furthermore, like reference numerals refer to like components throughout the specification, and reference numerals for identical components may be omitted in individual drawings.

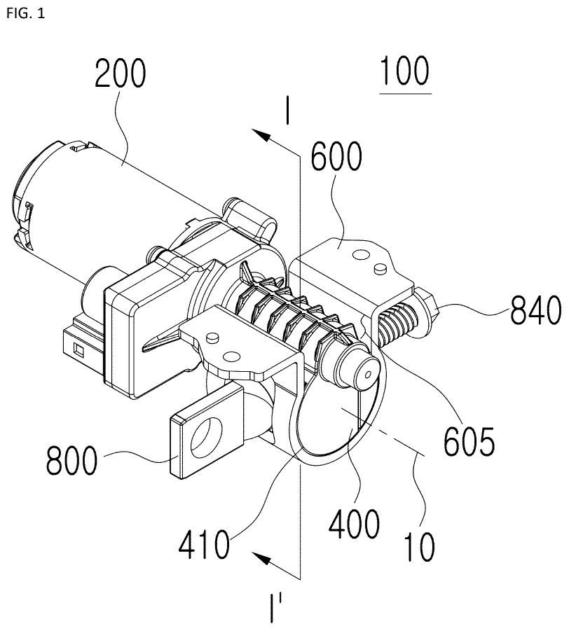

Referring to FIGS. 1 to 8, an assemblability-improved seat position adjustment apparatus 100 includes a driving unit 200, a gear part 400, a mounting part 600, and a rod part 800.

The assemblability-improved seat position adjustment apparatus 100 is coupled to a link connected to a vehicle seat, and when it is operated while fixed to a vehicle, a rail, or a seat frame via the mounting part 600, the rod part 800 is reciprocated by the driving unit 200, thereby raising or lowering the seat.

In the assemblability-improved seat position adjustment apparatus 100, when the rod part 800, during its movement, is shifted to different horizontal planes by the link or the seat, the driving unit 200 and the gear part 400, excluding the mounting part 600, rotate by a certain angle corresponding to the height of the rod part 800.

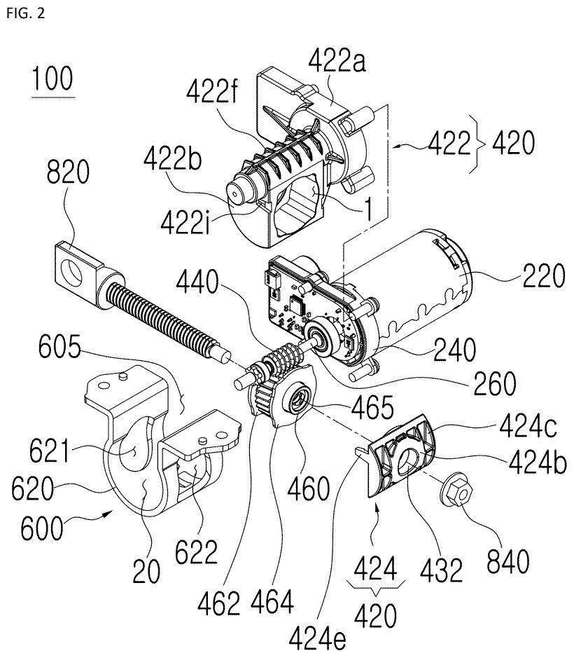

Referring to FIGS. 2 to 4, the driving unit 200 includes a motor 220, a drive control unit 240, and a drive shaft 260.

The driving unit 200 is coupled to one side of the gear part 400 and, by operation of the motor 220, rotates the drive shaft 260 about an axis extending bilaterally, thereby transmitting power to the gear part 400.

In detail, the motor 220 is formed in an elongated cylindrical shape extending bilaterally, is operated by a user's manipulation to rotate the drive shaft 260, and is coupled to the gear part 400 through the drive control unit 240, which is coupled to another side of the motor 220.

The drive control unit 240 incorporates a motor drive circuit, and the motor drive circuit receives a control signal from an external source based on the user's manipulation, and generates a drive signal for the motor 220 to drive the motor 220.

The drive shaft 260 is formed in a cylindrical shape extending a predetermined distance from the drive control unit 240 toward its other side, and rotates in a forward or reverse direction about its longitudinal axis by operation of the motor 220.

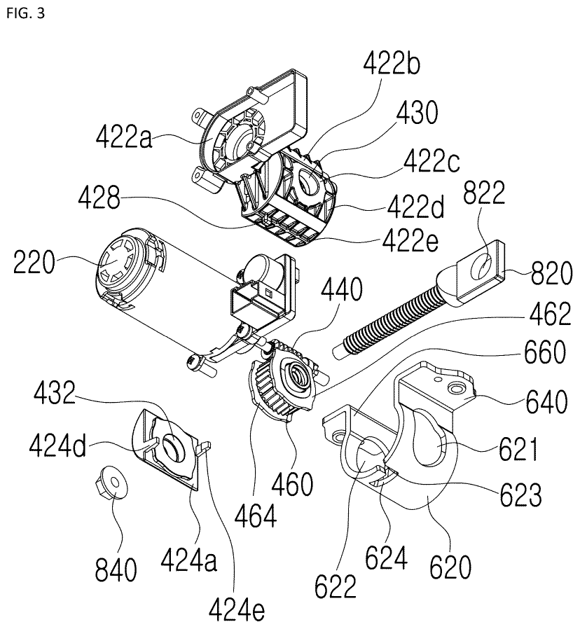

Referring to FIGS. 2 and 3, the gear part 400 includes a case 420, a worm 440, a gear nut 460, a first support member 462, and a second support member 464, and the case 420 includes a body 422, a cover 424, and a protrusion 428.

The gear part 400 has a curved surface part 410 formed on its outer lower portion, extending along a direction of rotation about a first axis 10 that extends bilaterally, and the gear part 400 is gear-coupled to the drive shaft 260 inserted therein, and transmits a rotational force of the drive shaft 260 to the rod part 800.

In detail, referring to FIGS. 2 and 3, one side of the case 420 is coupled to the drive control unit 240, another side of the case 420 is fabricated in a housing shape covering the worm 440 and the gear nut 460, and first and second hollows 430 and 432 are formed at the rear and front of the case 420, respectively, allowing a first space 1 inside the case 420 to communicate with the exterior.

A lower end portion of the other side of the case 420 is formed in an elongated cylindrical shape extending bilaterally, an upper end portion of the other side of the case 420 is formed such that an upper portion of the lower end portion protrudes upward by a certain distance and extends bilaterally.

Referring to FIGS. 2 to 6, the body 422 includes a first housing 422a, a second housing 422b, a guide member 422c, first ribs 422d, second ribs 422e, third ribs 422f, and a reinforcing member 422j.

In detail, one side of the body 422 is formed in a housing shape to cover another side of the drive control unit 240, a lower end portion of another side of the body 422 is fabricated in a pillar shape extending toward the other side by a certain distance, and an upper end portion of the other side of the body 422 is fabricated in a semi-cylindrical shape, wherein an upper portion of the lower end portion protrudes and extends bilaterally.

The first space 1, formed inside the lower end portion of the other side of the body 422, is fabricated to be open to an exterior space at the front of the lower end portion of the body 422, and the gear nut 460, the first support member 462, and the second support member 464 are inserted into the first space 1.

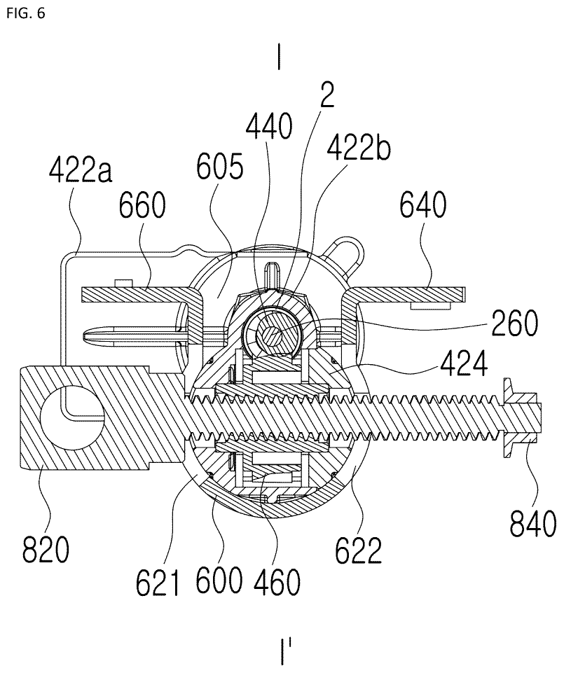

Referring to FIGS. 1 and 6, the upper end portion of the other side of the body 422 is arranged in an opening part 605 while the gear part 400 and the mounting part 600 are coupled to each other, and when the driving unit 200 and the gear part 400 move excessively with respect to the first axis 10, their movement is limited by brackets 640 and 660, which are arranged at the rear and front of the opening part 605, respectively.

Thus, when a problem occurs in the screw coupling between the gear part 400 and the rod part 800, and control of raising and lowering the seat is lost, the upper end portion of the other side of the body 422 advantageously collides with any one of the brackets 640 and 660, thereby preventing excessive raising or lowering of the seat.

Referring to FIG. 3, the first hollow 430 is fabricated such that a rear portion of the lower end portion of the other side of the body 422 is recessed forward by a certain distance, thereby allowing the first space 1 to communicate with a rear external space of the body 422, and the first hollow 430 also provides a passage function to allow a lead screw 820 to be inserted into the first space 1.

Referring to FIG. 2, the second hollow 432 is fabricated such that a front portion of the cover 424 is recessed rearward by a certain distance, thereby allowing a rear space of the cover 424 to communicate with a front external space of the cover 424.

Referring to FIGS. 2, 3, and 6, the first housing 422a is formed in an enclosure shape, with its inner space open toward one side, and is coupled to the other side of the drive control unit 240 to cover the drive control unit 240.

Referring to FIGS. 2, 3, and 6, a lower end portion of the second housing 422b is formed in a hexahedral shape such that the first space 1 therein is open toward the front, an upper end portion of the second housing 422b is fabricated in a semi-cylindrical shape, wherein an upper portion of the lower end portion protrudes upward and extends bilaterally, and a second space 2, which communicates with the first space 1, is formed inside the upper end portion.

Referring to FIG. 3, the first hollow 430 is formed as a central portion at a rear of the second housing 422b is recessed forward by a certain distance, which allows the first space 1 and a rear external space of the second housing 422b to communicate with each other, and the first hollow 430 is utilized as a passage for inserting the lead screw 820 into the first space 1.

Referring to FIG. 3, the guide member 422c is formed in a ring shape surrounding an opening portion of the first hollow 430, which is formed at a rear of the second housing 422b, and is then connected or coupled to the rear of the second housing 422b, and the guide member 422c guides the lead screw 820, inserted into the first hollow 430 and the first space 1, such that the lead screw 820 may move in a front-rear direction while rotating.

In detail, the guide member 422c is formed in a ring shape surrounding the opening portion of the first hollow 430, and the rear of the guide member 422c is machined such that a first curved surface is formed to extend along a direction of rotation about the first axis 10.

Referring to FIG. 3, each of a plurality of first ribs 422d is fabricated in a circular segment shape that extends in a vertical direction and protrudes convexly rearward, and the plurality of first ribs 422d are coupled to the second housing 422b while being arranged on the same horizontal line on opposite sides of the guide member 422c, spaced apart from each other by a certain distance.

A first connecting rib is formed between the plurality of first ribs 422d, connecting them and thereby improving durability, and this first connecting rib suppresses deformation of the first ribs 422d during a process in which the gear part 400 rotates within a first rotation space 20 inside the mounting part 600.

A rear outer surface of the plurality of first ribs 422d is in close contact with an inner surface of the mounting part 600 within the first rotation space 20, so as to constitute, together with a rear surface of the guide member 422c, a portion of the curved surface part 410, and the curved surface part 410 guides the gear part 400 such that the gear part 400 may rotate stably in the first rotation space 20 about the first axis 10.

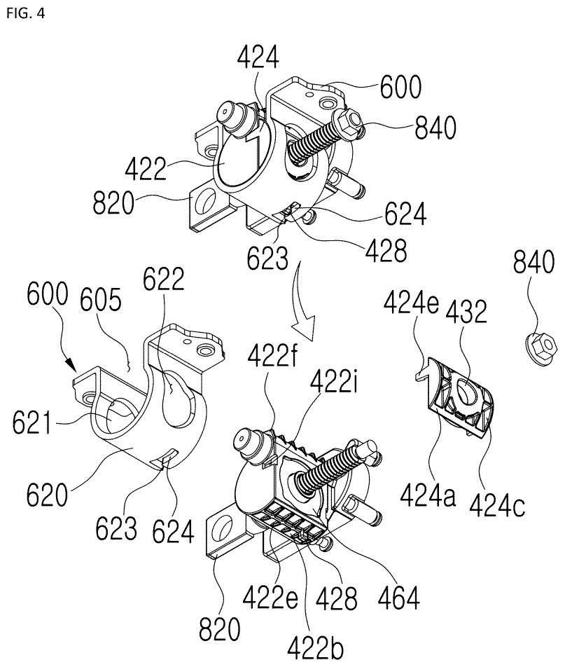

Referring to FIGS. 3 and 4, each of a plurality of second ribs 422e is fabricated in a circular segment shape that extends in a horizontal direction and protrudes convexly downward, and the plurality of second ribs 422e are coupled to a lower portion of the second housing 422b while being arranged from one side toward another on the same horizontal line, spaced apart from each other by a certain distance.

The plurality of second ribs 422e are connected to each other by a second connecting rib that extends bilaterally, thereby improving durability, and this second connecting rib suppresses deformation of the second ribs 422e during a process in which the gear part 400 rotates in the first rotation space 20.

Referring to FIG. 2, each of a plurality of third ribs 422f is fabricated in a circular segment shape that extends in a horizontal direction and protrudes convexly upward, and the plurality of third ribs 422f are coupled to an upper portion of the second housing 422b while being arranged from one side toward another on the same horizontal line, spaced apart from each other by a certain distance.

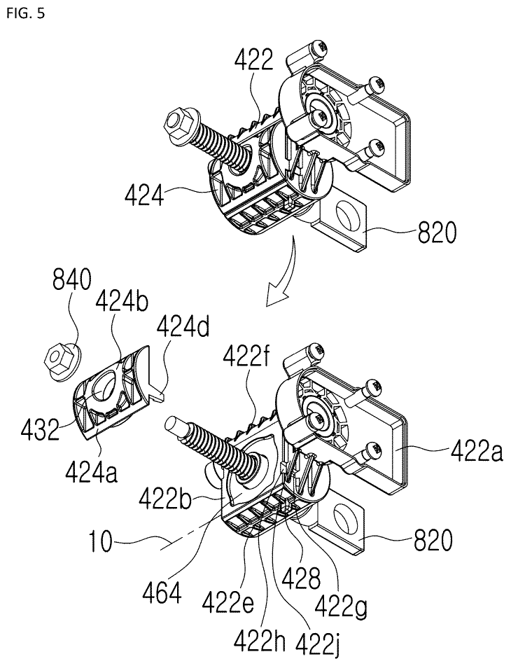

Referring to FIG. 5, an engagement groove 422g is formed as a quadrangular portion of one side surface, corresponding to a lower portion of one side of the second housing 422b, is recessed toward another side by a certain distance, and a portion of the cover 424 is inserted into the engagement groove 422g.

Referring to FIG. 2, an engagement groove 422i is formed as a quadrangular portion of another side surface, corresponding to an upper portion of the other side of the second housing 422b, is recessed toward one side by a certain distance, and a portion of the cover 424 is inserted into the engagement groove 422i and is then snap-fit coupled to the second housing 422b.

Referring to FIG. 5, an insertion groove 422h is formed as a portion of a front surface of one side of the second housing 422b, which is located on the same horizontal line as the engagement groove 422g, is recessed rearward by a certain distance, and the insertion groove 422h is connected to the engagement groove 422g.

Referring to FIG. 5, the reinforcing member 422j is fabricated in a rib shape connecting bottom surfaces of one side of the second housing 422b and the first housing 422a to each other, and a portion of the reinforcing member 422j covers one side of the insertion groove 422h and thus suppresses the phenomenon where a snap-fit coupling between an engagement member 424d, which is inserted into the insertion groove 422h, and the second housing 422b is released.

Referring to FIGS. 2 to 5, the cover 424 includes a cover body 424a, a guide member 424b, fourth ribs 424c, and engagement members 424d and 424e.

The cover 424 has a front surface protruding convexly forward, such that a curved surface extending along a rotation direction of the body 422 is formed at its front, and the second hollow 432 is formed as a central portion of this front surface is recessed rearward, allowing front and rear external spaces to communicate with each other.

The cover 424 is coupled to a front surface of a lower end portion of the other side of the body 422 to cover a front of the first space 1, and fixes the gear nut 460, the first support member 462, and the second support member 464, and during a process in which the gear part 400 rotates, the cover 424 comes into close contact with an inner surface of the mounting part 600 so as to guide the rotation of the gear part 400.

In detail, referring to FIGS. 3 to 5, the cover body 424a is formed in the shape of a quadrangular plate having, formed on its rear, a protrusion having the same shape as the second support member 464, and thus, the cover body 424a covers a front of the first space 1 while being in close contact with a front surface of the second housing 422b around the first space 1 and with the second support member 464.

The guide member 424b is formed in a ring shape surrounding a front opening portion of the second hollow 432 and is connected to a front surface of the cover body 424a, and the front of the guide member 424b is machined such that a second curved surface is formed to extend along a direction of rotation about the first axis 10.

Each of a plurality of fourth ribs 424c is fabricated in a circular segment shape that extends in a vertical direction on opposite sides of the guide member 424b and protrudes convexly forward, and the plurality of fourth ribs 424c are coupled to the front surface of the cover body 424a while being arranged from one side toward another on the same horizontal line, spaced apart from each other by a certain distance.

The first curved surface of the guide member 422c, the second curved surface of the guide member 424b, the first ribs 422d, the second ribs 422e, and the fourth ribs 424c, which are described above, together constitute the curved surface part 410, which has a curved shape, bent in the arc shape of a large circular segment.

The curved surface part 410 is in close contact with an inner surface of the mounting part 600, stably guides the rotation of the gear part 400 that is inserted into the first rotation space 20, and has the advantage of improving the durability of the gear part 400.

In addition, the curved surface part 410 may be configured by using the first ribs 422d, the second ribs 422e, and the fourth ribs 424c, excluding the guide members 422c and 424b, and in this case, outer curved surfaces of the guide members 422c and 424b may be recessed and thus spaced apart from the inner surface of the mounting part 600.

Inner edges of the guide members 422c and 424b may be machined to be tapered such that their inner diameters gradually increase toward the first space 1, thereby forming inner inclined surfaces, and in this case, the inner inclined surfaces formed in the guide members 422c and 424b have the advantage of seamlessly guiding the movement of the lead screw 820.

In a state in which the gear part 400 and the mounting part 600 are coupled to each other, the outer surface of each of the first curved surface of the guide member 422c, the second curved surface of the guide member 424b, the first ribs 422d, the second ribs 422e, and the fourth ribs 424c is in close contact with the inner surface of the mounting part 600.

In a state in which the gear part 400 is inserted into the first rotation space 20, the first curved surface, the second curved surface, the first ribs 422d, the second ribs 422e, and the fourth ribs 424c are in close contact with the inner surface of the mounting part 600, and during a process in which the gear part 400 rotates, the first curved surface, the second curved surface, the first ribs 422d, the second ribs 422e, and the fourth ribs 424c remain in close contact with the mounting part 600.

Referring to FIG. 5, one end of the engagement member 424d is formed in a stick shape extending forward and rearward and is then connected to a position corresponding to a rear portion and a lower portion of one side of the cover body 424a, another end of the engagement member 424d has a portion of its extremity protruding toward another side by a certain distance, thereby forming a first engagement projection.

During a process of coupling the body 422 and the cover 424 to each other, the engagement member 424d is inserted into the insertion groove 422h while moving rearward by a certain distance, and the first engagement projection is inserted into the engagement groove 422g.

During a process in which the engagement member 424d is inserted into the insertion groove 422h and then moves rearward, the first engagement projection has elastically moved toward one side, and when the first engagement projection moves to the engagement groove 422g, the first engagement projection is inserted into the engagement groove 422g while being elastically moved toward another side.

In a state in which the body 422 and the cover 424 are coupled to each other, the first engagement projection is inserted into the engagement groove 422g, which is formed on one side of the body 422, by the elastic restoring force of the engagement member 424d, thereby increasing the coupling force between the body 422 and the cover 424.

Referring to FIGS. 2 to 4, one end of the engagement member 424e is formed in a stick shape extending forward and rearward and is connected to a position corresponding to a rear portion and an upper portion of another side of the cover body 424a, and another end of the engagement member 424e has a portion of its extremity protruding toward one side by a certain distance, thereby forming a second engagement projection.

In a state in which the body 422 and the cover 424 are coupled to each other, the second engagement projection is inserted into the engagement groove 422i, which is formed on another side of the body 422, by the elastic restoring force of the engagement member 424e, thereby increasing the coupling force between the body 422 and the cover 424.

Referring to FIGS. 2 to 4, the protrusion 428 protrudes downward by a certain distance from a center of the second rib 422e, which is arranged at a position spaced apart from one side surface of the second housing 422b by a first separation distance, and is formed in a hexahedral shape.

The protrusion 428 is arranged to be relatively closer to one side surface of the second housing 422b than to another side surface of the second housing 422b, and during a process in which the second housing 422b is inserted into the first rotation space 20 from one side of the mounting part 600, the protrusion 428 is inserted into a sliding groove 624 through a slot groove 623.

In a state in which the protrusion 428 is inserted into the sliding groove 624, a portion of the protrusion 428 protrudes toward a lower side of the mounting part 600 by a certain distance, and while guiding a rotation direction of the driving unit 200 and the gear part 400, prevents the gear part 400 from being separated from the mounting part 600.

Referring to FIGS. 2, 3, and 6, one end of the worm 440 is coupled to another end tip of the drive shaft 260 in the second space 2, and another end of the worm 440 is fabricated to extend from the one end toward another side by a certain distance.

A screw thread formed on an outer side of the worm 440 is fabricated to extend spirally toward another side, rotating counterclockwise from an outer surface of one end of the worm 440 when the worm 440 is viewed from the one side.

Referring to FIG. 2, the gear nut 460 is formed in a cylindrical shape surrounding a through-hole 465, which extends in a horizontal direction within the first space 1, a screw thread is formed on an inner surface of the gear nut 460 located in the through-hole 465, and a plurality of teeth are arranged on an outer surface of the gear nut 460, spaced apart from each other at equal distances along the outer surface of the gear nut 460.

The teeth formed on the outer side of the gear nut 460 engage with the screw thread formed on the worm 440 at a lower portion of the worm 440, and when the drive shaft 260 and the worm 440 rotate forward or in reverse, the gear nut 460 rotates forward or in reverse about an axis extending in a horizontal direction.

The screw thread formed on the inner surface of the gear nut 460 is fabricated in a shape that extends spirally toward a front of the gear nut 460 while rotating clockwise from a rear inner surface of the gear nut 460, and is then coupled to the inner surface of the gear nut 460 at the through-hole 465.

The first support member 462 is formed in a quadrangular washer shape and surrounds a rear portion of the gear nut 460, and an outer surface of the first support member 462, located at its edge, is fixed to the second housing 422b while being in close contact with an inner surface of the second housing 422b within the first space 1.

The second support member 464 is formed in a quadrangular washer shape and surrounds a front portion of the gear nut 460, and an outer surface of the second support member 464, located at its edge, is fixed to the second housing 422b while being in close contact with an inner surface of the second housing 422b within the first space 1.

The gear nut 460 is arranged between the first and second support members 462 and 464 in the first space 1, and when rotated forward or in reverse by the worm 440, the gear nut 460 rotates while its position is fixed on the same horizontal line and the same vertical line by the first and second support members 462 and 464.

When the driving unit 200 is viewed from one side of the driving unit 200, when the drive shaft 260 rotates clockwise, i.e., in the forward rotation direction, the worm 440 rotates forward, and when the gear nut 460 is viewed from the rear, the gear nut 460 rotates forward in the clockwise direction.

When the gear nut 460 rotates forward in the clockwise direction, the lead screw 820 moves rearward by a certain distance, in proportion to a rotation count of the drive shaft 260, and the seat connected to the lead screw 820 is then lowered or raised.

Conversely, when the driving unit 200 is viewed from one side of the driving unit 200, when the drive shaft 260 rotates counterclockwise, i.e., in the reverse rotation direction, the worm 440 rotates in reverse, and when the gear nut 460 is viewed from the rear, the gear nut 460 rotates in reverse in the counterclockwise direction.

When the gear nut 460 rotates in reverse in the counterclockwise direction, the lead screw 820 moves forward by a certain distance, in proportion to a rotation count of the drive shaft 260, and the seat connected to the lead screw 820 is then lowered or raised.

Depending on a coupling structure between a seat and the assemblability- improved seat position adjustment apparatus 100, a direction of seat movement, which is caused by a forward movement direction of the lead screw 820, may be directed downward or upward.

Furthermore, depending on the coupling structure between the seat and the assemblability-improved seat position adjustment apparatus 100, a direction of seat movement, which is caused by a rearward movement direction of the lead screw 820, may be directed downward or upward.

Referring to FIGS. 1 to 4, the mounting part 600 includes a guide 620 and the brackets 640 and 660.

The mounting part 600 is formed in a shape surrounding the curved surface part 410 formed on the gear part 400 and is coupled to the gear part 400 such that the gear part 400 may rotate about the first axis 10, and rear and front portions of the mounting part 600, which are spaced apart from each other with the gear part 400 therebetween, are recessed to form first and second through-holes 621 and 622, respectively.

A lower end portion of the mounting part 600 is fabricated by bending a plate, which extends forward and rearward, into the arc shape of a large circular segment that protrudes convexly downward, so as to surround the first rotation space 20, the opening part 605 is formed in an upper portion of the lower end portion, and an inner surface of the lower end portion is in close contact with the curved surface part 410.

Upper end tips of the lower end portion of the mounting part 600 are arranged on a horizontal line relatively higher than the first axis 10, to be spaced apart from each other at the rear and front, respectively, with the opening part 605 therebetween, such that the mounting part 600 inserted into the first rotation space 20 is stably fixed.

In detail, the guide 620 is fabricated in a shape surrounding the curved surface part 410, which is formed in a lower end portion of another side of the case 420, and the inner surface of the guide 620 is in close contact with the guide member 422c, the first ribs 422d, the second ribs 422e, the guide member 424b, and the fourth ribs 424c.

The first through-hole 621 is formed as a central portion of a rear surface of the guide 620 is recessed forward by a certain distance, thereby allowing the first rotation space 20, into which the second housing 422b is inserted, to communicate with a rear external space of the guide 620.

The second through-hole 622 is formed as a central portion of a front surface of the guide 620 is recessed rearward by a certain distance, thereby allowing the first rotation space 20 to communicate with a front external space of the guide 620.

In a state in which the lower end portion of the other side of the case 420 is inserted into the first rotation space 20, the first through-hole 621 communicates with the first hollow 430 formed in the second housing 422b, and the second through-hole 622 communicates with the second hollow 432.

The lead screw 820, after passing through the first through-hole 621, the first hollow 430, the through-hole 465, the second hollow 432, and the second through-hole 622, is screw-coupled to the gear nut 460 and moves forward or rearward according to a rotation direction of the drive shaft 260.

The slot groove 623 is formed as a portion of one side surface of the guide 620 located below the first rotation space 20 is recessed toward another side by a certain distance, thereby communicating with the sliding groove 624 such that the first rotation space 20 communicates with a lower external space of the guide 620.

In detail, the slot groove 623 is fabricated as, in a state in which a seat is positioned on a horizontal line corresponding to a maximum height or a minimum height, a portion of one side surface of the guide 620, which is located on a horizontal line relatively higher than that where the protrusion 428 is located, is recessed toward another side by a certain distance, thereby communicating with the sliding groove 624.

The length of the slot groove 623 is relatively smaller than the distance between another side surface of the guide 620 and the sliding groove 624, and is relatively smaller than the length of the sliding groove 624, and consequently, the volume of a portion of the guide 620, which needs to be removed for machining the slot groove 623 and the sliding groove 624, is reduced, thereby improving the durability of the guide 620.

The slot groove 623 is always arranged on a horizontal line relatively higher than the protrusion 428, regardless of the position of the protrusion 428, which rotates about the first axis 10 according to raising or lowering of the seat in a state in which the mounting part 600 is arranged and fixed at a position spaced apart from the seat. thereby preventing the phenomenon of the protrusion 428 being moved to the slot groove 623 by an external force, and enabling a stable coupling force between the gear part 400 and the mounting part 600.

Furthermore, because the assembly between the gear part 400 and the mounting part 600 is completed in a state in which the protrusion 428 is inserted into the sliding groove 624, the use of fasteners, including rivets, is unnecessary and the weight of the case 420 is reduced.

In addition, the slot groove 623 may be fabricated such that an upper portion of one side surface of the guide 620 located below the first rotation space 20 is recessed toward another side by a certain distance so as to communicate with the sliding groove 624 and to be blocked from a lower external space of the guide 620.

The sliding groove 624 is formed by recessing a portion of the guide 620, which corresponds to a path along which the protrusion 428 moves while the seat moves by a maximum distance during a process of raising or lowering the seat, thereby connecting the first rotation space 20 and a lower external space of the guide 620.

The distance between one side surface of the guide 620, which is located on the same horizontal line as the sliding groove 624, and the sliding groove 624 is relatively smaller than the distance between another side surface of the guide 620, which is located on the same horizontal line as the sliding groove 624, and the sliding groove 624.

In addition, the sliding groove 624 may be fabricated such that a portion of an inner surface of the guide 620, which corresponds to the path along which the protrusion 428 moves while the seat moves by a maximum distance during a process of raising or lowering the seat, is recessed downward by a certain distance, and is blocked from a lower external space of the guide 620.

In a case in which the slot groove 623 and the sliding groove 624 are fabricated to be blocked from a lower external space of the guide 620, a bottom surface of the protrusion 428, when inserted into the slot groove 623 or the sliding groove 624, is arranged on a horizontal line relatively higher than a bottom surface of the guide 620.

In a state in which the mounting part 600 is rotated forward by a certain angle about the first axis 10 such that the first through-hole 621 faces rearward and downward and the mounting part 600 is arranged on another side of the gear part 400, when the mounting part 600 is then moved toward one side, the protrusion 428 is inserted into a rear end portion of the sliding groove 624 through the slot groove 623.

Then, when the mounting part 600 is rotated in reverse by a certain angle about the first axis 10, the first through-hole 621 and the second through-hole 622 communicate with each other on the same horizontal line through the first hollow 430 and the second hollow 432, and the protrusion 428 is arranged at a center of the sliding groove 624.

In a state in which the mounting part 600 is fixed to a seat or a rail, the rod part 800 is screw-coupled to the gear part 400 while passing through the gear part 400 and the mounting part 600, and a rear end tip of the rod part 800 is rotatably coupled to a link connected to the seat, about an axis extending bilaterally.

One end of the bracket 640 is formed in a vertical plate shape that extends bilaterally and is perpendicular to a floor, and this end is connected to a rear upper end of the guide 620, and another end of the bracket 640 is fabricated such that an upper portion of the one end extends rearward by a certain distance.

One end of the bracket 660 is formed in a vertical plate shape that extends bilaterally and is perpendicular to a floor, and this end is connected to a front upper end of the guide 620, and another end of the bracket 660 is fabricated such that an upper portion of the one end extends forward by a certain distance.

The opening part 605, which communicates with the first rotation space 20, is formed between one end of bracket 640 and one end of bracket 660, and an upper end portion of another side of the case 420 is arranged in the opening part 605 to move forward or rearward relative to the first axis 10 while rotating.

The mounting part 600 is coupled to a rail, a chassis, or a seat frame installed in a vehicle by using the brackets 640 and 660, and when the position of the rod part 800 is changed by a seat and a link that are raised or lowered by operation of the driving unit 200, the mounting part 600 guides the gear part 400 to rotate stably about the first axis 10.

In addition, the second housing 422b may be inserted into the first rotation space 20 to form an interference fit coupling with the guide 620, and in this case, a frictional force between the curved surface part 410 and an inner surface of the guide 620 increases to enable stable rotation of the gear part 400.

The rod part 800 includes the lead screw 820 and a nut 840.

Referring to FIGS. 1 to 4, the rod part 800 is formed in an elongated rod shape extending in a horizontal direction and is fabricated to be screw-coupled to the gear part 400 after passing through the first through-hole 621, the gear part 400, and the second through-hole 622.

In detail, referring to FIG. 3, one end of the lead screw 820 is fabricated in a quadrangular plate shape having a hole 822 formed therein to penetrate a center of opposite side surfaces, and this end is coupled to a link or a seat to be rotatable about an axis extending bilaterally.

A central portion of the lead screw 820 is fabricated in a shape where a screw thread is formed on an outer surface of a cylinder extending in a horizontal direction, and the central portion extends forward from one end by a certain distance and, after sequentially passing through the first through-hole 621, the first hollow 430, the through-hole 465, the second hollow 432, and the second through-hole 622, is screw-coupled to the screw thread formed on the inner surface of the gear nut 460.

The screw thread formed on the outer surface of the central portion of the lead screw 820 is fabricated to extend spirally forward by a certain distance, while rotating clockwise along the outer surface of the lead screw 820, from a rear of the central portion of the lead screw 820.

The length of the central portion of the lead screw 820 is preferably equal to the distance that the lead screw 820 needs to move while the seat moves upward or downward between a maximum height and a minimum height of the seat.

Another end of the lead screw 820 is formed as a central portion of a front surface of the central portion protrudes forward by a certain distance into a cylindrical shape, and a screw thread is formed on an outer surface of this end to be coupled to the nut 840.

The nut 840 is screw-coupled to another end of the lead screw 820, which protrudes to the front of the mounting part 600 at a position corresponding to the front of the mounting part 600, and if necessary, the lead screw 820 and the nut 840 may be coupled via welding.

The nut 840 is fabricated such that the length between its opposing parallel sides is relatively larger than the diameter of the second hollow 432, and when the lead screw 820 moves excessively rearward, rearward movement of the nut 840 is blocked by the cover 424, thereby preventing the phenomenon where the lead screw 820 is separated from the gear nut 460.

The height of one end of the lead screw 820 is relatively larger than the diameter of the first hollow 430, and when the lead screw 820 moves excessively forward, the phenomenon where this one end of the lead screw 820 moves forward is blocked by the second housing 422b, thereby preventing the phenomenon where the lead screw 820 is separated from the gear nut 460 or moves excessively forward.

When the drive shaft 260 and the worm 440 rotate forward, the gear nut 460 rotates forward in the clockwise direction when viewed from the rear, and the lead screw 820 moves rearward by a certain distance to lower or raise the seat.

When the drive shaft 260 and the worm 440 rotate in reverse, the gear nut 460 rotates in reverse in the counterclockwise direction when viewed from the rear, and the lead screw 820 moves forward by a certain distance to lower or raise the seat.

During a process in which the lead screw 820 moves rearward by a certain distance, when the seat is raised and one end of the lead screw 820 is consequently raised, the driving unit 200 and the gear part 400 rotate by a certain angle in the counterclockwise direction about the first axis 10 when the driving unit 200 is viewed from one side of the driving unit 200.

During a process in which the lead screw 820 moves forward by a certain distance, when the seat is lowered and one end of the lead screw 820 is consequently lowered, the driving unit 200 and the gear part 400 rotate by a certain angle in the clockwise direction about the first axis 10 when the driving unit 200 is viewed from one side of the driving unit 200.

By controlling the driving unit 200 to adjust the rotation count of the drive shaft 260, the distance that the lead screw 820 moves forward or rearward may be controlled, and accordingly, the phenomenon where the protrusion 428 moves to the slot groove 623 while rotating is prevented.

For example, during a process of raising or lowering the seat, while the gear part 400 rotates, the protrusion 428 reciprocates only along the sliding groove 624, and the slot groove 623 is always arranged on a horizontal line relatively higher than the protrusion 428 while the gear part 400 rotates, and thus, the phenomenon where the protrusion 428 escapes to an exterior space through the slot groove 623 is prevented.

Therefore, during a process of raising or lowering the seat, the protrusion 428 slides only within the sliding groove 624, and the phenomenon where the protrusion 428 passes through the slot groove 623 and then escapes to an exterior space is prevented, and thus, the phenomenon where the gear part 400 and the mounting part 600 are separated from each other during a seat raising or lowering driving process is also prevented.

The length of the central portion of the lead screw 820 is preferably equal to the distance that the lead screw 820 needs to move while the seat moves upward or downward between a maximum height and a minimum height of the seat, and here, because movement of the lead screw 820 is limited by the nut 840 or one end of the lead screw 820 in a state in which the seat is moved to a maximum height or a minimum height, there is an advantage that excessive raising or lowering of the seat is prevented and weight reduction is possible.

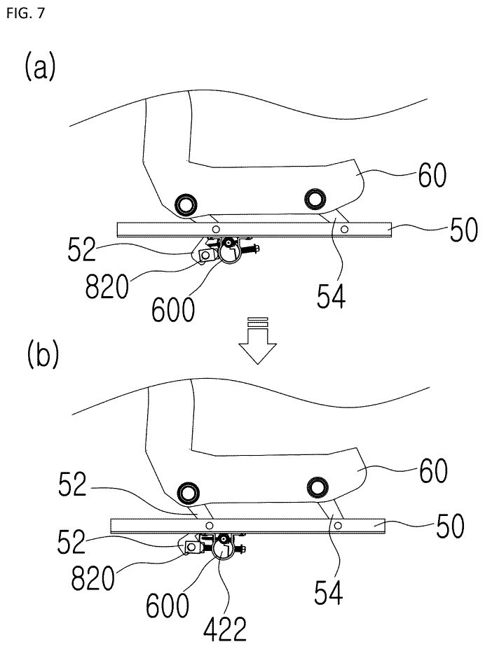

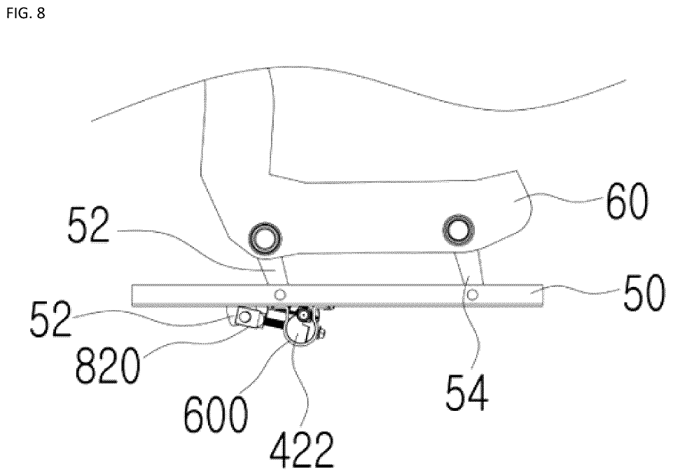

Referring to FIGS. 7 and 8, the assemblability-improved seat position adjustment apparatus 100 may be coupled to a rail 50 of a vehicle by using the mounting part 600, and the rod part 800 may be rotatably coupled to a lower portion of a first link 52 connected to a seat frame 60.

The rail 50 is fabricated in an elongated shape extending in a horizontal direction and is coupled to a frame of the vehicle, and the seat frame 60 is coupled to the rail 50 by using first and second links 52 and 54 to be movable upward or downward.

In detail, one end of the first link 52 is coupled to one end of the lead screw 820 to be rotatable about an axis extending bilaterally, a central portion of the first link 52 extends by a certain distance to be inclined forward and upward, and is coupled to the rail 50 to be rotatable about an axis extending bilaterally, and another end of the first link 52 extends to be inclined rearward and upward and is coupled to the seat frame 60 to be rotatable about an axis extending bilaterally.

One end of the second link 54 is coupled to the rail 50 at the front of the first link 52 to be rotatable about an axis extending bilaterally, and another end of the second link 54 extends by a certain distance to be inclined rearward and upward, and is coupled to the seat frame 60 to be rotatable about an axis extending bilaterally.

Referring to FIG. 1 and (a) of FIG. 7, by reverse rotation of the drive shaft 260, the lead screw 820 moves forward by a certain distance, one end of the first link 52 is lowered in a direction inclined forward and downward, and another end of the first link 52 and the seat frame 60 are lowered in a direction inclined rearward and downward.

At this time, the seat frame 60 is arranged at a first position corresponding to the minimum height of the seat, forward movement of one end of the lead screw 820 is blocked by the second housing 422b, and one end of the lead screw 820 is arranged on a horizontal line relatively lower than the first axis 10 due to the rotation of the driving unit 200 and the gear part 400.

Referring to (b) of FIG. 7, by forward rotation of the drive shaft 260, the lead screw 820 moves rearward by a certain distance, one end of the first link 52 is raised in a direction inclined rearward and upward, and another end of the first link 52 and the seat frame 60 are raised in a direction inclined forward and upward.

At this time, the seat frame 60 is arranged at a second position corresponding to a horizontal line relatively higher than the above-described first position, the lead screw 820 and the nut 840 are arranged at positions spaced apart from the mounting part 600, and in the drawing, the driving unit 200 and the gear part 400 rotate by a certain angle in the clockwise direction about the first axis 10 relatively more than the driving unit 200 and the gear part 400 illustrated in (a) of FIG. 7.

Referring to FIG. 8, by forward rotation of the drive shaft 260, the lead screw 820 moves rearward by a certain distance relatively more than the lead screw 820 illustrated in (b) of FIG. 7, one end of the first link 52 is raised in a direction inclined rearward and upward, and another end of the first link 52 and the seat frame 60 are raised in a direction inclined forward and upward.

At this time, the seat frame 60 is arranged at a third position corresponding to a horizontal line relatively higher than the above-described second position, the nut 840 is in close contact with the second housing 422b, and in the drawing, the driving unit 200 and the gear part 400 rotate by a certain angle in the clockwise direction about the first axis 10 relatively more than the driving unit 200 and the gear part 400 illustrated in (b) of FIG. 7.

The assemblability-improved seat position adjustment apparatus 100 may be installed by fixing it to the rail 50 as illustrated in FIGS. 7 and 8, and the shape of the first link 52 may be modified according to the position at which the mounting part 600 is fixed.

In addition, the rod part 800 of the assemblability-improved seat position adjustment apparatus 100 may be coupled to the seat frame 60, instead of the first link 52, to be rotatable about an axis extending bilaterally, and in this case, the seat frame 60 may be raised or lowered by operation of the driving unit 200.

Therefore, unlike conventional inventions, because the coupling between the gear part 400 and the mounting part 600 in the assemblability-improved seat position adjustment apparatus 100 is performed in a slot manner, the use of brackets and rivets for coupling between the gear part 400 and the mounting part 600 is unnecessary, which provides the advantage that the overall weight is reduced.

Furthermore, unlike conventional inventions, in the assemblability-improved seat position adjustment apparatus 100, the mounting part 600 is formed in a shape that surrounds and is in close contact with an outer portion of the gear part 400, which provides the advantage that the weight of material used for fabrication is reduced and assembly between the gear part 400 and the mounting part 600 is facilitated.

In addition, unlike conventional inventions, in the assemblability-improved seat position adjustment apparatus 100, the gear part 400 is rotatably coupled to the mounting part 600 such that an outer portion of the gear part 400 is in close contact with an inner surface of the mounting part 600, which provides the advantage that it is unnecessary to use separate brackets and rivets to rotatably couple the mounting part 600 to the gear part 400.

Furthermore, because the guide 620 is bent in the arc shape of a large circular segment surrounding the curved surface part 410 and is in close contact with the curved surface part 410, a phenomenon where the second housing 422b passes through the opening part 605 and then escapes to the exterior is prevented by the guide 620, and thus, there is the advantage that it is unnecessary to use separate brackets and rivets for stable rotational coupling between the gear part 400 and the mounting part 600.

In addition, because the mounting part 600 is fabricated in a bearing bracket shape with an opening portion formed on its upper portion by bending a plate-shaped material, the volume of the material is minimized, machining of the material is facilitated, and the cross-sectional thickness of the mounting part 600 surrounding the gear part 400 is uniform, thereby enabling an improved weight reduction effect.

Furthermore, in the assemblability-improved seat position adjustment apparatus 100, in a state in which the mounting part 600 is coupled to the seat or the seat frame 60, the rod part 800 may be rotatably coupled to a link that is coupled to the rail 50, and in this case, the seat frame 60 may be raised or lowered according to the movement direction of the rod part 800.

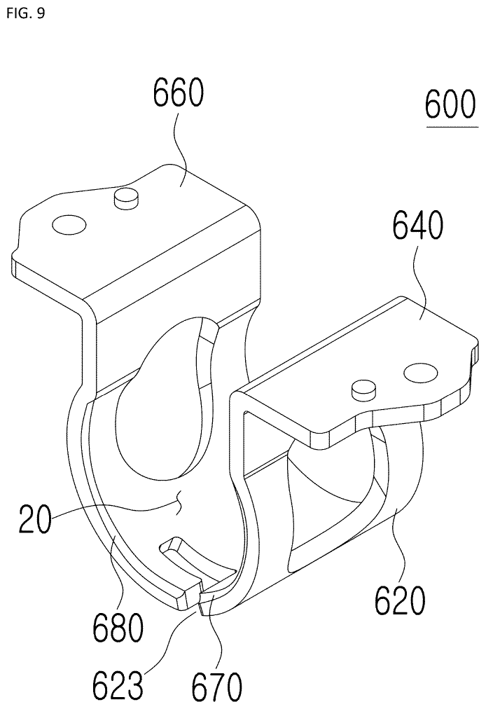

In addition, referring to FIG. 9, in the mounting part 600, inner edges of one side surface of the guide 620, which are spaced apart from each other on the respective rear and front sides of the slot groove 623, may be machined to be tapered, such that a first inclined surface 670 and a second inclined surface 680 may be formed.

The first inclined surface 670 and the second inclined surface 680 provide the advantage of guiding the gear part 400 to be quickly and accurately inserted into the first rotation space 20 during a process in which the gear part 400 is inserted into the first rotation space 20 from one side of the mounting part 600.

Although preferred embodiments of the present disclosure have been described above with reference to the accompanying drawings, the embodiments described herein and the configurations illustrated in the drawings are merely examples of preferred embodiments of the present disclosure and do not represent the entire technical spirit of the present disclosure. Therefore, it should be understood that various equivalents and modifications that may replace these elements could exist at the time of filing the present application. Therefore, the embodiments described above are to be considered in all respects as illustrative and not restrictive. The scope of the present disclosure is indicated by the appended claims rather than by the foregoing description. All changes or modifications that come within the meaning and range of equivalency of the claims are therefore intended to be embraced within the scope of the present disclosure.

### PRIOR ART DOCUMENTS

### Patent Documents

(Patent Document 1) Korean Patent Registration No. 10-0885096

(Patent Document 2) Korean Patent Publication No. 10-2014-0066582

### LIST OF REFERENCE NUMERALS FOR MAJOR ELEMENTS

100: Assemblability-improved seat position adjustment apparatus
200: Driving unit
400: Gear part
600: Mounting part
800: Rod part

1. A seat position adjustment apparatus with improved assemblability comprising:
a driving unit comprising a motor in which a drive shaft is formed;
a gear part, wherein a curved surface part extending along a direction of rotation about a first axis extending bilaterally is formed in an outer portion of the gear part, and the gear part is gear-coupled to the drive shaft;
a rod part coupled to the gear part such that the rod part passes through the gear part, receives power from the drive shaft, and moves forward or rearward; and
a mounting part, wherein upper portions of a curved plate structure surrounding the curved surface part at a front and a rear of the gear part, respectively, envelop the rod part to form respective through-holes each having a vertical length that is relatively greater than a vertical thickness of the rod part,
wherein, in a state in which the mounting part is fixed, a seat connected to the rod part is moved in accordance with a movement of the rod part.

2. The seat position adjustment apparatus with improved assemblability of claim 1, wherein the mounting part is formed in an arc shape of a large circular segment, is in close contact with the curved surface part, and is coupled to the gear part to be able to slide along the direction of rotation about the first axis.

3. The seat position adjustment apparatus with improved assemblability of claim 2, wherein the gear part comprises:
a case, wherein a plurality of ribs forming the curved surface part are formed on an outer side of the case, and hollows are formed at a front and a rear of the case to open an internal space to an exterior such that the rod part passes therethrough; and
a protrusion formed to protrude from a lower portion of the case.

4. The seat position adjustment apparatus with improved assemblability of claim 3, wherein, in the mounting part, a sliding groove into which the protrusion is inserted is formed by recessing a portion of the mounting part that corresponds to a path along which the protrusion rotationally moves about the first axis during a movement of the seat.

5. The seat position adjustment apparatus with improved assemblability of claim 4, wherein, in the mounting part, a slot groove connected to the sliding groove is formed by recessing a portion of one side surface of the mounting part toward the sliding groove.

6. The seat position adjustment apparatus with improved assemblability of claim 5, wherein an inner edge of one side surface of the mounting part is machined to be tapered such that an inclined surface is formed.

7. The seat position adjustment apparatus with improved assemblability of claim 4, wherein the gear part further comprises:
a worm coupled to the drive shaft in the internal space; and
a gear nut, wherein, in the internal space, an inner surface of the gear nut is screw-coupled to the rod part, and an outer surface of the gear nut is gear-coupled to the worm.
